(19) United States
(12) Patent Application Publication
(10) Pub. No.: US 2012/0121049 A1
(43) Pub. Date: May 17, 2012

(54) INITIAL PHASE ESTIMATOR TO ACCELERATE CARRIER PHASE RECOVERY

(76) Inventor: Ayham Al-Banna, Orlando Park, IL (US)

(21) Appl. No.: 12/945,603

(22) Filed: Nov. 12, 2010

(51) Int. Cl. H04L 7/00

(52) U.S. Cl. 375/354

(57) ABSTRACT

Methods for accelerating a fine carrier phase and frequency offset recovery algorithm in a receiver of a communication system are provided. More specifically, a method for estimating and compensating for an initial phase offset of a received signal provided. Computing an initial phase shift and compensating for it can reduce the time needed to provide fine estimation and compensation for carrier phase and frequency offset. Furthermore, computing an initial phase shift and compensating for it also can improve system performance by reducing the non-linearity that otherwise would be introduced into the system by fine carrier phase and frequency offset algorithms.

### TECHNICAL FIELD

This disclosure relates to accelerating carrier phase recovery algorithms.

### BACKGROUND

In a communication system, information is transmitted via message signals through a physical channel from a source to a destination. For example, a DOCSIS system can be used to deliver high-definition digital entertainment and telecommunications such as video, voice, and high-speed Internet over a cable network between a headend and a cable modem located at a subscriber premise. The cable network can take the form of an all-coax, all-fiber, or hybrid fiber/coax (HFC) network.

Message signals conveying information to be transmitted can undergo modulation prior to transmission. Modulation generally is the process of superimposing a message signal on a carrier signal that is suitable for transmission over a physical channel. More specifically, during modulation, a message signal is used to control the parameters (e.g., amplitude, frequency, and/or phase) of a carrier signal so as to superimpose the message signal on the carrier signal. To recover the message signal at the receiver, the received modulated message signal is demodulated.

Generally, coherent demodulation requires knowledge of the parameters of the carrier signal. Accordingly, synchronization algorithms such as carrier recovery algorithms exist to estimate the parameters of the carrier signal to perform optimal demodulation. However, existing synchronization algorithms may not converge to optimal parameters in a timely manner and may introduce non-linearity into the system that can reduce system performance.

### BRIEF DESCRIPTION OF THE DRAWINGS

FIG. 1 illustrates an example digital communication system for transmitting information from a transmitter to a receiver.

FIG. 2 illustrates an example process that can accelerate a carrier phase recovery algorithm in a receiver of a communication system.

FIGS. 3A-3C illustrate example demodulators 300 or portions thereof that can implement the example process of FIG. 2.

FIG. 4 is an example block diagram of a broadband communications device operable to perform the example process of FIG. 2.

### DETAILED DESCRIPTION

Various implementations of this disclosure estimate and compensate for an initial phase offset to, among other things, enable faster convergence of a fine carrier phase and frequency offset algorithm.

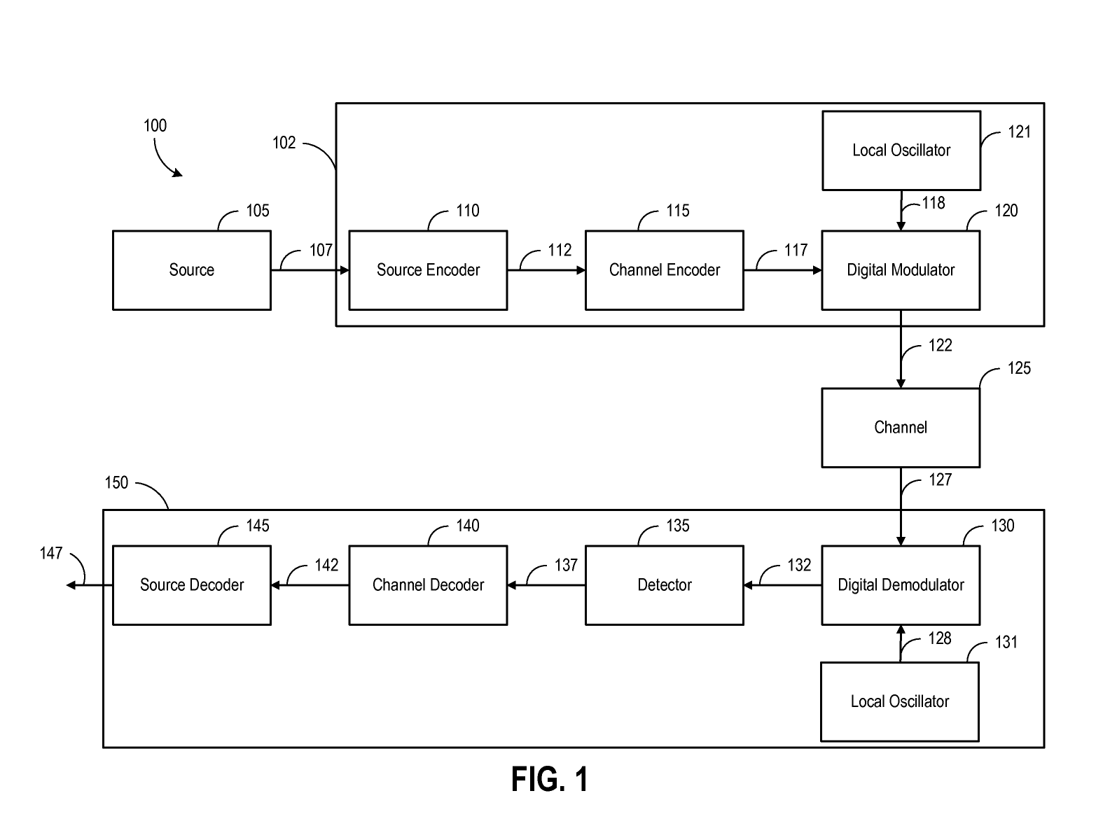

FIG. 1 illustrates an example digital communication system 100 for transmitting information from a transmitter 102 to a receiver 150. This disclosure is not limited to digital systems but can apply to analog systems as well. In the system 100, a source 105 outputs a digital signal 107. The source encoder 110 converts the digital signal 107 to a sequence of binary bits and compresses the binary bits to produce a compressed digital bit stream 112. Because transmission of a waveform representing a digital bit stream through a physical channel can cause the waveform to become corrupted, a channel encoder 115 can introduce redundancy in the digital bit stream 112 to produce an encoded digital bit stream 117.

The digital modulator 120 can modulate a carrier signal 118 generated by a local oscillator 121 based on blocks of k bits of the digital bit stream 117 (i.e., message signals) to produce a modulated carrier waveform 122. Numerous modulation techniques exist and this disclosure in not limited to any particular modulation technique. For instance, this disclosure applies to both digital and analog modulation, baseband and bandpass modulation, binary and M-ary modulation, memoryless modulation and modulation with memory, and linear and nonlinear modulation.

The modulated waveforms 122 are transmitted through the physical channel 125. Transmission of the waveforms through the physical channel 125 can distort the waveforms 122 and produce distorted waveforms 127 at the receiver 150.

To recover the message signal at the receiver 150, the received modulated waveform 127 can be demodulated by digital demodulator 130. The method of demodulation can be dependent on the modulation technique. As discussed above, numerous modulation techniques exist. This disclosure is not limited to any particular modulation or demodulation technique.

Demodulator 130 can demodulate the modulated waveform 127, for example, by multiplying the modulated waveform 127 by a signal 128 produced by a local oscillator 131. Ideally, local oscillator 131 should have the same frequency as local oscillator 121 and should be synchronous in phase with local oscillator 121 for optimal demodulation.

However, transmitters and receivers might not share the same oscillator, and the different oscillators in the transmitter and receiver might not generate signals having the same frequency even when designed to do so. Furthermore, the different oscillators in the transmitter and receiver generally are not synchronous in phase and the phase offset may be time varying. Still further, the propagation delay of the waveform 122 from the transmitter 102 to the receiver 150 can result in a phase offset between local oscillators 121 and 131.

Accordingly, for optimal or near optimal coherent demodulation, a demodulator that implements one or more synchronization algorithms such as carrier recovery algorithms, as discussed below, can be used to estimate and compensate for the frequency and phase offset between local oscillators 121 and 131. Without synchronization algorithms it can be difficult to accurately detect the symbols that were transmitted.

Demodulator 130 can further filter and sample the waveforms 127 to produce groups of k bits 132. An equalizer can be used to compensate for linear channel distortion such as amplitude and phase distortion caused by a non-ideal physical channel frequency-response. An equalizer can be implemented in or after the demodulator 130.

A detector 135 attempts to determine the k-bit symbols that were transmitted based on the output of the demodulator 130. The detector 135 produces a bit stream 137.

The channel decoder 140 attempts to reconstruct the compressed bit stream 112 from the received bit stream 137 using its knowledge of the coding scheme of channel encoder 115 and the redundancy introduced by channel encoder 115. The reconstructed bit stream 142 produced by channel decoder 140 is passed to source decoder 140, which attempts to reconstruct the original digital signal 107. The distortion introduced by the digital system 100 can be measured by the difference between the original digital signal 107 and the reconstructed digital signal 147.

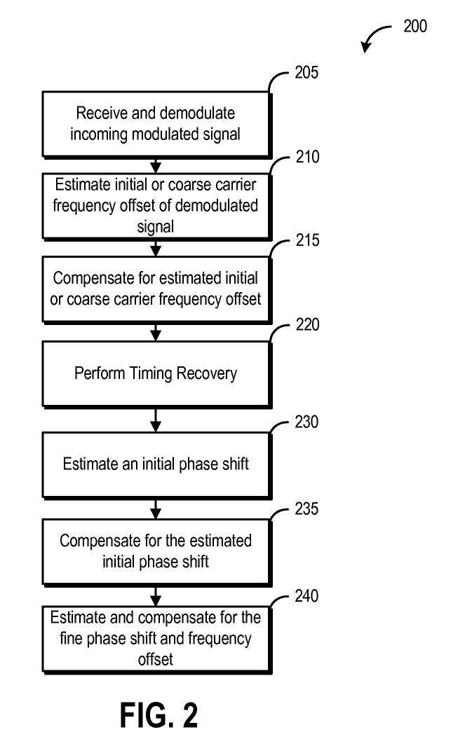

FIG. 2 illustrates an example process 200 that can accelerate a carrier phase recovery algorithm in a receiver of a communication system. In some implementations, process 200 can be performed by one or more programmable processors or can also be performed by, and apparatus can also be implemented as, special purpose logic circuitry, e.g., an ASIC (application specific integrated circuit). The process 200 can be implemented with any existing or later developed demodulation techniques and synchronization algorithms. The synchronization algorithms can be, for example, data-aided or decision-directed.

At stage 205, an incoming modulated signal is received and demodulated using a nominal carrier frequency to provide a baseband signal. One of ordinary skill in the art would know how to demodulate a signal using a nominal carrier frequency to provide a baseband signal. Modulated signals may be received from, for example, wireline channels, fiber optics channels, or wireless channels. This disclosure is not limited to any particular type of modulated signal.

At stage 210, an initial or coarse carrier frequency offset of the demodulated signal is estimated. The initial or coarse carrier frequency offset of the demodulated signal can be estimated, for example, by a signal processor running an algorithm for estimating an initial or coarse carrier frequency offset. One of ordinary skill in the art would know how to estimate the initial or coarse carrier frequency offset of a demodulated signal using any of the numerous existing or later developed algorithms for estimating initial or coarse carrier frequency offset.

At stage 215, the estimated initial or coarse carrier frequency offset of the demodulated signal is compensated. By demodulating the incoming signal with the nominal carrier frequency and compensating for the estimated initial or coarse carrier frequency offset, the frequency offset of the demodulated signal can be minimize or eliminated.

At stage 220, timing recovery including interpolation and decimation is performed. One of ordinary skill in the art would know how to perform timing recovery using any of the numerous existing or later developed algorithms for timing recovery.

At stage 230, an initial phase shift is estimated. In some implementations, the initial phase shift is estimated as the constant phase shift between the transmitter and receiver clocks that can be due to the propagation delay and the lack of synchronization between the transmitter and receiver oscillators, for example. By estimating and using the initial phase shift, faster convergence of a subsequent fine carrier phase and frequency offset recovery algorithm may be achieved. Furthermore, estimating and using the initial phase shift estimate can reduce non-linear distortion caused by the fine carrier phase and frequency offset recovery algorithm. Reducing non-linear distortion can aide subsequent stages of the receiver to perform optimally, such as the equalization stage.

In some implementations, a course estimation of the initial phase shift can be determined by first assuming that a known training sequence is transmitted during an initial transmission. The known training sequence can be expressed as:

y(n)=Σₖ a(k)·δ(n−k)

where a(k) is a sequence of complex data symbols. Since the frequency offset can be compensated for at stage 210, it further can be assumed that demodulated training sequence in the receiver has a constant phase shift, φₒ, that can be due to the propagation delay from the transmitter to the receiver and the lack of synchronization between the transmitter and receiver oscillators. Accordingly, the training sequence can be expressed as:

x(n)=Σₖ a(k)·e^{jφ}^{ₒ}·δ(n−k)=^{jφ}^{ₒ} Σₖ a(k)·δ(n−k)

Since the incoming training data symbols are known, the correlation property can be used to estimate the initial phase shift, φₒ. Thus,

r(n)=x(n)*y*(n)=rₐ(n)·e^{jφ}^{ₒ}

where rₐ(n) is the autocorrelation function of the training data symbols a(n), which takes real value at the maximum.

Thus, the initial phase shift, φₒ, can be initially estimated as:

φₒ=arg (max(r(n))).

At stage 235, the estimated initial phase shift of the incoming signal is compensated by, for example, multiplying the samples from stage 220 by e^{-jφ}^{ₒ}.

At stage 240, the resulting signal from stage 235 is provided as the input to a fine carrier phase and frequency offset recovery algorithm to provide fine estimation and compensation of the phase shift and frequency offset of the incoming signal. The estimated phase shift and frequency offset of the incoming can be compensated by, for example, using a multiplier or signal processor to multiply the resulting signal from stage 235 by e^{-jψ}, where ψ can be the accumulated phase shift, to compensate for the carrier phase and frequency offset. In some implementations, the fine estimation and compensation of the phase shift and frequency offset can be performed on a continuous basis by using tracking loops that continuously update the estimates. One of ordinary skill in the art would know how to estimate and compensate for the phase shift and frequency offset of an incoming signal using any of the numerous existing or later developed fine carrier phase and frequency offset recovery algorithms.

In some implementations, stage 235 may be eliminated and instead the initial phase shift estimated at stage 230 can be provided as an initial condition to the fine carrier phase and frequency offset recovery algorithm implemented at stage 240.

Computing an initial phase shift and compensating for it can reduce the time needed for fine estimation of the carrier phase and frequency offset during the training period and, therefore, minimizes the errors that may occur to the data symbols due to the inaccuracy of estimating the carrier phase and carrier frequency offset. Furthermore, computing an initial phase shift and compensating for it during an initial transmission period also can improve system performance by reducing the non-linearity that otherwise would be introduced into the system by fine carrier phase and frequency offset algorithms.

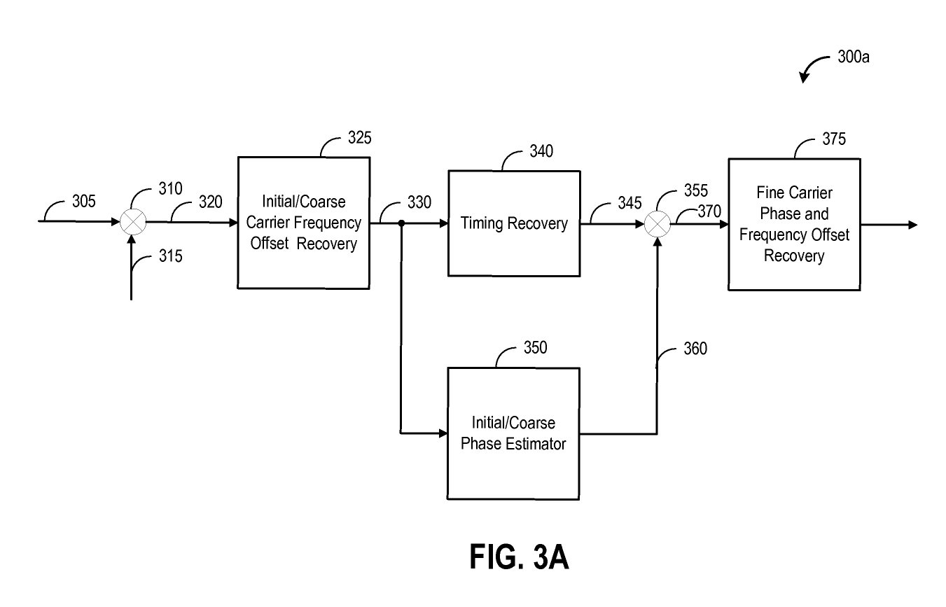

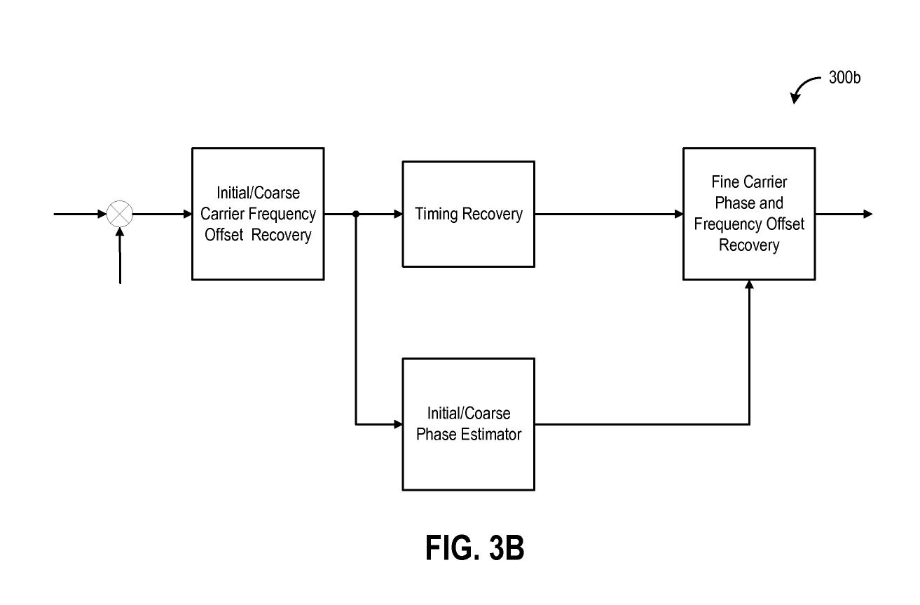

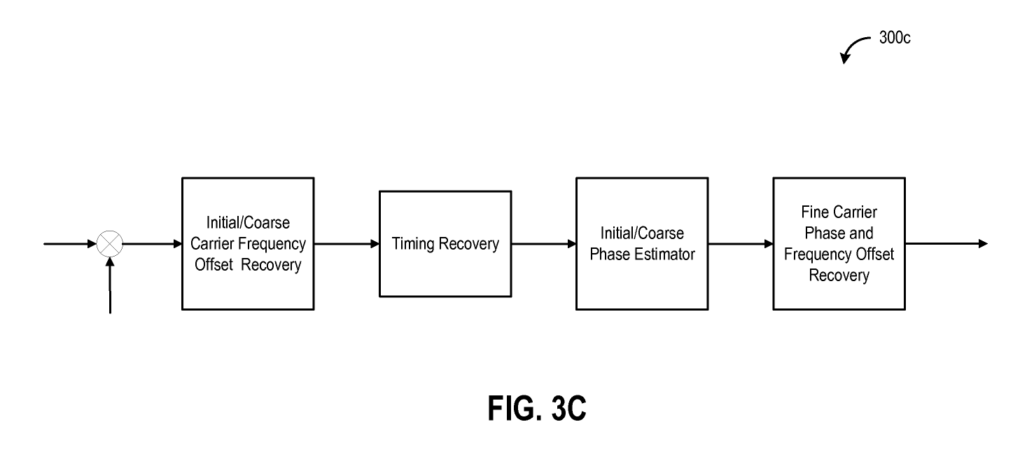

FIGS. 3A-3C illustrate example demodulators or portions thereof that can implement the example process of FIG. 2.

Referring to FIG. 3A, the demodulator 300a can include one or more mixers 310 to demodulate an incoming signal 305 using one or more waveforms 315 based on the nominal carrier frequency to produce a demodulated signal 320.

The demodulator 300a also can include an initial or coarse carrier frequency offset recovery block 325 that implements an initial or coarse carrier frequency offset algorithm to estimate the initial or coarse carrier frequency offset of the demodulated signal 320 and compensate for it. The initial or coarse carrier frequency offset recovery block 325 can produce a resulting signal 330 where the frequency offset of the demodulated signal 320 has been minimize or eliminated. In some implementations, one or more mixers using one or more waveforms based on the estimated initial or coarse carrier frequency offset can be included in the carrier frequency offset recovery block 325 to compensate for the carrier frequency offset. One of ordinary skill in the art would know how to implement an initial or coarse carrier frequency offset recovery block 325 to estimate an initial or coarse carrier frequency offset.

The demodulator 300a also includes a timing recovery block 340 that implements a timing recovery algorithm and provides samples 345. One of ordinary skill in the art would know how to implement a timing recovery block 340 to function as described in stage 220.

The demodulator 300 also includes an initial or coarse phase estimator 350 that provides an estimate of the initial phase shift, φₒ, of the baseband signal in accordance with stage 230 above. In some implementations, a multiplier 355 multiplies the samples 345 by e^{-jφ}^{ₒ} 360 to compensate for the estimate initial phase shift, φₒ.

The resulting signal 370 is then fed to a fine carrier phase and frequency offset recovery block 375 that implements a fine carrier phase and frequency offset recovery algorithm to provide fine estimation and compensation for the phase and frequency offset of the incoming signal. In some implementations, one or more mixers using one or more waveforms based on the estimated fine phase and frequency offset can be included in the fine carrier phase and frequency offset recovery block 375 to compensate for the phase and frequency offset. One of ordinary skill in the art would know how to implement a fine carrier phase and frequency offset recovery block 375 that implements a fine carrier phase and frequency offset recovery algorithm to provide fine estimation and compensation for the phase and frequency offset of the incoming signal.

FIG. 3B illustrates another example demodulator 300b or a portion thereof that can implement the example process of FIG. 2. In this implementation, the initial phase shift estimated by the initial or coarse phase estimator 350 can be provided as an initial condition to the fine carrier phase and frequency offset recovery algorithm implemented by the fine carrier phase and frequency offset recovery block 375.

FIG. 3C illustrates another example demodulator 300c or a portion thereof that can implement the example process of FIG. 2. In this implementation, the initial or coarse phase estimator 350 is provided after the timing recovery block 340.

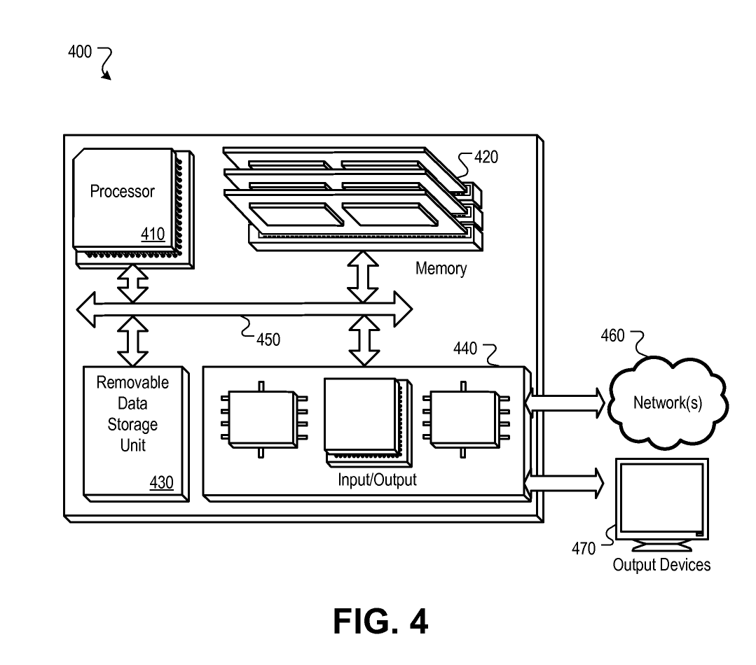

FIG. 4 is a block diagram of a broadband communications device operable to perform process 200. The receiver device 400 can include a processor 410, a memory 420, a removable data storage unit 430, and an input/output device 440. Each of the components 410, 420, 430, and 440 can, for example, be interconnected using a system bus 450. The processor 410 is capable of processing instructions for execution within the receiver device 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the device 400. In one implementation, the memory 420 is a computer-readable medium. In one implementation, the memory 420 is a volatile memory unit. In another implementation, the memory 420 is a non-volatile memory unit.

In some implementations, the removable data storage unit 430 is capable of providing mass storage for the device 400. In one implementation, the storage device 430 is a computer-readable medium. In various different implementations, the storage device 430 can, for example, include a hard disk device, an optical disk device, flash memory or some other large capacity storage device.

The input/output device 440 provides input/output operations for the device 400. In one implementation, the input/output device 440 can include one or more of a wireless interface, network interface 460, such as, for example, an IP network interface device, e.g., an Ethernet card, a cellular network interface, a serial communication device, e.g., and RS-232 port, and/or a wireless interface device, e.g., and 802.11 card. In another implementation, the input/output device can include driver devices configured to receive input data and send output data to other input/output devices (e.g., a monitor 470), as well as sending communications to, and receiving communications from various networks.

The device (e.g., a receiver device) of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be operable to interface with a computing device having a display, e.g., a CRT (cathode ray tube) or LCD (liquid crystal display) monitor, for displaying information to the user and a keyboard and a pointing device, e.g., a mouse or a trackball, by which the user can provide input to the computer.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method for synchronizing a receiver, the method comprising:
demodulating an incoming modulated signal and compensating for carrier frequency offset;
estimating an initial phase shift of the incoming modulated signal; and
compensating for the initial phase shift.

2. The method of claim 1 wherein the incoming modulated signal includes a known training sequence and estimating an initial phase shift of the incoming modulated signal comprises estimating the initial phase shift during an initial transmission when the known training sequence is transmitted.

3. The method of claim 2 wherein the initial phase shift is a constant phase shift of the incoming modulated signal due to a propagation delay and lack of oscillator synchronization between a transmitter and receiver of the modulated signal

4. The method of claim 2 wherein estimating an initial phase shift further comprises multiplying the known training sequence with the complex conjugate of the demodulated signal and determining the angle of the result when the result is maximum.

5. The method of claim 1 wherein compensating for the initial phase shift comprises processing the demodulated signal based on the estimated initial phase shift.

6. The method of claim 1 wherein compensating for the initial phase shift comprises providing the initial phase shift as an initial condition to a synchronization algorithm that estimates carrier parameters during a data transmission period.

7. A computer readable medium having instructions for causing a computer to execute a method comprising:
demodulating an incoming modulated signal and compensating for carrier frequency offset;
estimating an initial phase shift of the incoming modulated signal; and
compensating for the initial phase shift.

8. The computer readable medium of claim 7 wherein the incoming modulated signal includes a known training sequence and estimating an initial phase shift of the incoming modulated signal comprises estimating the initial phase shift during an initial transmission when the known training sequence is transmitted.

9. The method of claim 8 wherein the initial phase shift is a constant phase shift of the incoming modulated signal due to a propagation delay and lack of oscillator synchronization between a transmitter and receiver of the modulated signal

10. The computer readable medium of claim 8 wherein estimating an initial phase shift further comprises multiplying the known training sequence with the complex conjugate of the demodulated signal and determining the angle of the result when the result is maximum.

11. The computer readable medium of claim 7 wherein compensating for the initial phase shift comprises processing the demodulated signal based on the estimated initial phase shift.

12. The computer readable medium of claim 7 wherein compensating for the initial phase shift comprises providing the initial phase shift as an initial condition to a synchronization algorithm that estimates carrier parameters during a data transmission period.

13. An system for synchronizing a receiver, the system comprising:
means for demodulating an incoming modulated signal and compensating for carrier frequency offset;
means for estimating an initial phase shift of the incoming modulated signal; and
means for compensating for the initial phase shift.
